(19) United States
(12) Patent Application Publication
(10) Pub. No.: US 2016/0356879 A1
(43) Pub. Date: Dec. 8, 2016

(54) POSITIONING TARGET TERMINAL, POSITIONING NODE, AND POSITIONING SYSTEM

(71) Applicant: KABUSHIKI KAISHA TOSHIBA, Minato-ku (JP)

(72) Inventors: Yuji TOHZAKA, Kawasaki (JP); Takafumi Sakamoto, Machida (JP); Yusuke Doi, Kawasaki (JP)

(73) Assignee: KABUSHIKI KAISHA TOSHIBA, Minato-ku (JP)

(21) Appl. No.: 14/938,970

(22) Filed: Nov. 12, 2015

(30) Foreign Application Priority Data
Jun. 2, 2015 (JP) 2015-112476

(51) Int. Cl. G01S 5/18; G10K 11/18

(52) U.S. Cl. CPC G01S 5/18; G10K 11/18

(57) ABSTRACT

A positioning target terminal according to an embodiment includes a wireless communicator and a positioning calculator. The wireless communicator has a connection function and time synchronization function with the positioning node, and acts as a master of time synchronization. The positioning calculator performs a positioning calculation based on a reception time of a sound wave transmitted from the positioning node or a reception time of a sound wave received by the positioning node.

### CROSS REFERENCE TO RELATED APPLICATION(S)

This application is based upon and claims the benefit of priority from the prior Japanese Patent Application No. 2015-112476, filed on Jun. 2, 2015, the entire contents of which are incorporated herein by reference.

### FIELD

Embodiments described herein relate generally to a positioning target terminal, a positioning node, and a positioning system.

### BACKGROUND

Conventionally, a positioning system which positions a positioning target terminal existing indoors using an sound wave has been proposed. In the positioning system, times of positioning nodes installed at three or more indoor places are synchronized, and the sound waves are each transmitted from the positioning nodes. The positioning target terminal receives the sound wave transmitted from each positioning node, calculates the distance from each positioning node based on the propagation time of the sound wave, and calculates the own position.

In the conventional positioning system, a certain positioning node transmits the reference time and another positioning node receives the reference time, whereby the time synchronization of the positioning node has been performed. Consequently, there has been a problem that a range where the positioning target terminal can be positioned (positionable range) is limited to a communicable range of the positioning node which transmits the reference time.

### BRIEF DESCRIPTION OF THE DRAWINGS

FIG. 1 is a diagram illustrating a positioning system according to a first embodiment;

FIG. 2 is a functional block diagram illustrating an example of a positioning node according to the first embodiment;

FIG. 3 is a diagram illustrating an example of a hardware configuration of a wireless communicator of FIG. 2;

FIG. 4 is a functional block diagram illustrating an example of a sound wave transmitter of FIG. 2;

FIG. 5 is a functional block diagram illustrating an example of a positioning target terminal according to the first embodiment;

FIG. 6 is a functional block diagram illustrating an example of a sound wave transmitter of FIG. 5;

FIG. 7 is a sequence diagram illustrating processing in the positioning system according to the first embodiment;

FIG. 8 is a flowchart illustrating operations of the positioning target terminal according to the first embodiment;

FIG. 9 is a flowchart illustrating operations of the positioning node according to the first embodiment;

FIG. 10 is a functional block diagram illustrating an example of a positioning node according to a second embodiment;

FIG. 11 is a functional block diagram illustrating an example of a positioning target terminal according to the second embodiment;

FIG. 12 is a sequence diagram illustrating processing in the positioning system according to the second embodiment;

FIG. 13 is a flowchart illustrating operations of the positioning target terminal according to the second embodiment;

FIG. 14 is a flowchart illustrating operations of the positioning node according to the second embodiment;

FIG. 15 is a diagram illustrating a positioning system according to a third embodiment;

FIG. 16 is a functional block diagram illustrating an example of a positioning target terminal according to the third embodiment;

FIG. 17 is a functional block diagram illustrating an example of a positioning server according to the third embodiment;

FIG. 18 is a sequence diagram illustrating processing in the positioning system according to the third embodiment;

FIG. 19 is a functional block diagram illustrating an example of a positioning target terminal according to a fourth embodiment;

FIG. 20 is a sequence diagram illustrating processing in the positioning system according to the fourth embodiment;

FIG. 21 is a diagram illustrating a positioning system according to a fifth embodiment; and

FIG. 22 is a flowchart illustrating operations of a positioning target terminal according to the fifth embodiment.

### DETAILED DESCRIPTION

Embodiments will now be explained with reference to the accompanying drawings. The present invention is not limited to the embodiments.

A positioning target terminal according to an embodiment includes a wireless communicator and a positioning calculator. The wireless communicator has a connection function and time synchronization function with the positioning node, and acts as a master of time synchronization. The positioning calculator performs a positioning calculation based on a reception time of a sound wave transmitted from the positioning node or a reception time of a sound wave received by the positioning node.

### First Embodiment

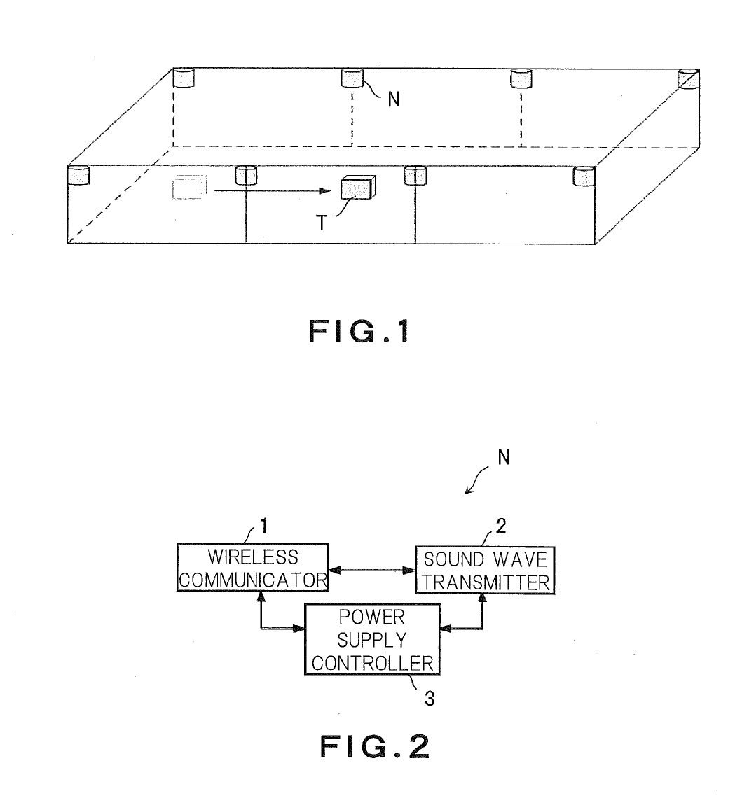

A positioning system according to a first embodiment will be described with reference to FIGS. 1 to 9. The positioning system according to the present embodiment is used to measure a position of (position) a positioning target terminal existing in a building, such as a factory or a power plant.

FIG. 1 is a diagram illustrating the positioning system according to the present embodiment. As illustrated in FIG. 1, the positioning system according to the present embodiment includes a plurality of positioning nodes N and a positioning target terminal T.

### Positioning Node

The positioning node N is a wireless communication device for positioning the positioning target terminal T. Each positioning node N is used by installing an indoor predetermined position as illustrated in FIG. 1. In the example of FIG. 1, although eight positioning nodes are installed, the number of the positioning nodes N included in the positioning system is not limited to this.

FIG. 2 is a functional block diagram illustrating an example of the positioning node N according to the present embodiment. As illustrated in FIG. 2, the positioning node N according to the present embodiment includes a wireless communicator 1, a sound wave transmitter 2, and a power supply controller 3.

The wireless communicator 1 transmits and receives information by wirelessly connecting with an external device including the positioning target terminal T. The wireless communicator 1 includes an analog signal processing circuit, a digital signal processing circuit, and an antenna. The wireless communicator 1 has a general function necessary for the wireless communication, such as a connection function and time synchronization function with the external device. Furthermore, the wireless communicator 1 may store the identifier and position information of the own node.

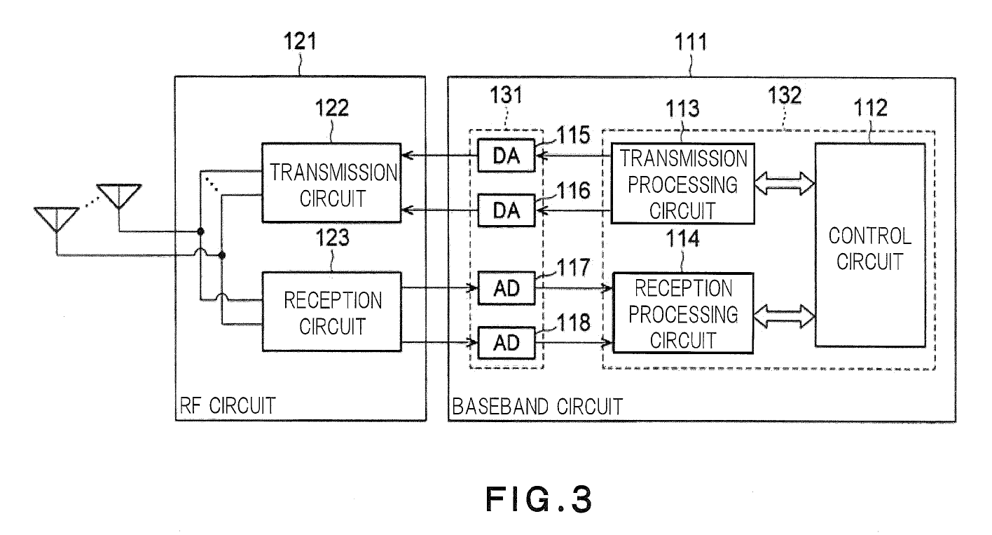

FIG. 3 is a diagram illustrating an example of a hardware configuration of the wireless communicator 1. As illustrated in FIG. 3, the wireless communicator 1 according to the present embodiment is constituted of a baseband circuit 111, an RF circuit 121, and an antenna.

The baseband circuit 111 includes a control circuit 112, a transmission processing circuit 113, a reception processing circuit 114, DA converters 115 and 116, and AD converters 117 and 118. The baseband circuit 111 is, for example, a baseband LSI or a baseband integrated circuit (IC). In the example of FIG. 3, the baseband circuit 111 includes two chips of ICs 131 and 132 as indicated by a dashed line in FIG. 3. The IC 131 includes the DA converters 115 and 116, and the AD converters 117 and 118. The IC 132 includes the control circuit 112, the transmission processing circuit 113, and the reception processing circuit 114.

The control circuit 112 performs the processing related to the communication with the external device and exchanges information between the sound wave transmitter 2 and the power supply controller 3. Specifically, the control circuit 112 processes a MAC frame and performs various types of processing of a MAC layer. Furthermore, the control circuit 112 may perform processing of a layer upper than the MAC layer (for example, a TCP/IP, a UDP/IP, or an application layer upper than them). The control circuit 112 performs a connection processing and time synchronization processing with the external device.

The transmission processing circuit 113 receives the MAC frame from the control circuit 112. The transmission processing circuit 113 adds preamble and a PHY header to the MAC frame, and encodes and modulates the MAC frame. Thus, the transmission processing circuit 113 converts the MAC frame into a PHY packet.

The DA converters 115 and 116 DA-convert the PHY packet output by the transmission processing circuit 113. In the example of FIG. 3, although two systems of the DA converters are provided and perform parallel processing, the DA converter may be one or may be provided by the number of antennas.

The RF circuit 121 is, for example, an RF/analog IC or a high frequency IC. The RF circuit 121 and the baseband circuit 111 may be integrated in a single chip. The RF circuit 121 includes a transmission circuit 122 and a reception circuit 123.

The transmission circuit 122 performs analog signal processing to the PHY packet DA-converted by the DA converters 115 and 116. The analog signal output by the transmission circuit 122 is wirelessly transmitted via the antenna. The transmission circuit 122 includes a transmission filter, a mixer, and a power amplifier (PA).

The transmission filter extracts a signal in a desired band from the signal of the PHY packet DA-converted by the DA converters 115 and 116. The mixer up-converts the signal filtered by the transmission filter to a radio frequency signal using a signal supplied from an oscillator and having a fixed frequency. The PA amplifies the up-converted signal. The amplified signal is supplied to the antenna, and the wireless signal is transmitted.

The reception circuit 123 performs the analog signal processing to the signal received by the antenna. The signal output by the reception circuit 123 is input to the AD converters 117 and 118. The reception circuit 123 includes a low noise amplifier (LNA), a mixer, and a reception filter.

The LNA amplifies the signal received by the antenna. The mixer down-converts the amplified signal to a baseband signal using the signal supplied from the oscillator and having a fixed frequency. The reception filter extracts a signal in a desired band from the down-converted signal. The extracted signal is input to the AD converters 117 and 118.

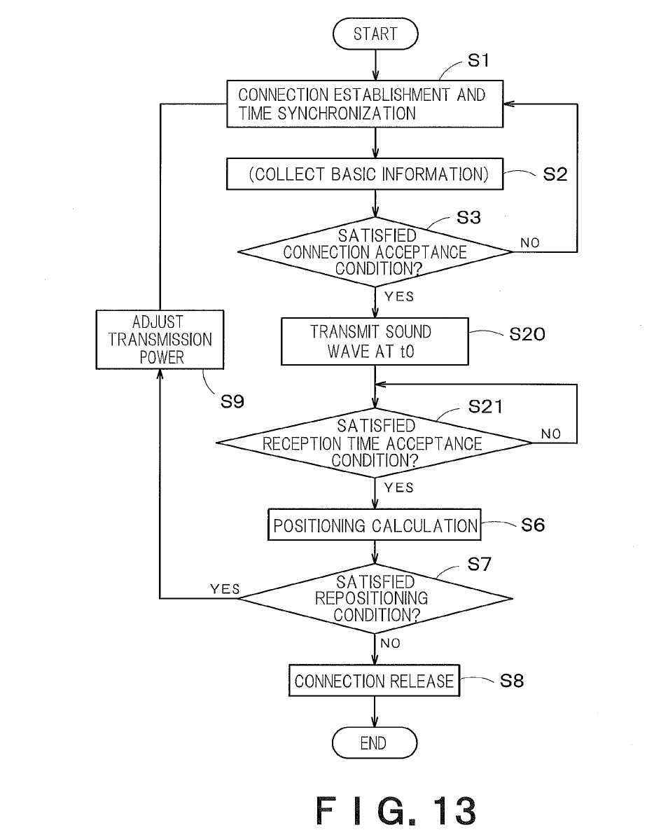

The AD converters 117 and 118 AD-convert the signal input from the reception circuit 123. In the example of FIG. 13, although two systems of the AD converters are provided and perform parallel processing, the AD converter may be one or may be provided by the number of antennas.

The reception processing circuit 114 receives the PHY packet AD-converted by the AD converters 117 and 118. The reception processing circuit 114 demodulates and decodes the PHY packet, and removes the preamble and the PHY header from the PHY packet. Thus, the reception processing circuit 114 converts the PHY packet into the MAC frame. The frame processed by the reception processing circuit 114 is input to the control circuit 112.

The sound wave transmitter 2 transmits the sound wave to the positioning target terminal T. The sound wave includes an ultrasound wave. FIG. 4 is a functional block diagram illustrating an example of the sound wave transmitter 2. As illustrated in FIG. 4, the sound wave transmitter 2 includes a binary code generator 21, a carrier wave generator 22, a modulator 23, a speaker 24, and a controller 25.

The binary code generator 21 generates a binary code sequence. The binary code sequence is, for example, a pseudo-noise sequence known for an M-sequence. The binary code sequence of each positioning node N may be common or unique. A specified pseudo-noise sequence may be used as the common binary code sequence between the positioning nodes N. Furthermore, a pseudo-noise sequence uniquely generated from transmission source information (the identifier of each positioning node N) or a pseudo-noise sequence set to each positioning node N can be used as the unique binary code sequence of each positioning node N.

The carrier wave generator 22 generates a carrier wave having a predetermined frequency to transmit the binary code sequence.

The modulator 23 performs a narrow band modulation to the binary code sequence using the carrier wave generated by the carrier wave generator 22. The narrow band modulation is, for example, but not limited to, phase shift keying (PSK) or frequency shift keying (FSK).

The speaker 24 includes a speaker which outputs the sound wave, a power amplifier, and a bandpass filter. The speaker 24 outputs the signal generated by the modulator 23 as the sound wave. Thus, the sound wave having the transmission source information is transmitted. Hereinafter, although it is assumed that the speaker 24 outputs the sound wave, the speaker 24 may output a sound wave in an audible band.

The controller 25 exchanges information between the wireless communicator 1 and the power supply controller 3 and reads setting information, such as the identifier or time information of the own node. The controller 25 controls the sound wave transmitter 2 based on the information acquired from the wireless communicator 1 and the power supply controller 3 or the setting information. Specifically, the controller 25 notifies the binary code generator 21 of the identifier of the own node. Furthermore, the controller 25 notifies the carrier wave generator 22 of a carrier frequency. Moreover, the controller 25 controls the timing so that the sound wave is transmitted at a transmission time specified by the positioning target terminal T.

The power supply controller 3 controls the power supply of the sound wave transmitter 2 based on the connection state of the wireless communicator 1. The power supply controller 3 functions as a low power consumption starting circuit of the positioning node N. Specifically, the power supply controller 3 supplies the power to the sound wave transmitter 2 to transmit the sound wave, stops the power to the sound wave transmitter 2 after transmitting the sound wave, and adjusts the power supplied to the sound wave transmitter 2 to change the output of the sound wave.

### Positioning Target Terminal

The positioning target terminal T is the wireless communication device to be positioned. The positioning target terminal T moves in the building where the positioning nodes N are installed as illustrated in FIG. 1. FIG. 5 is a functional block diagram illustrating an example of the positioning target terminal T according to the present embodiment. As illustrated in FIG. 5, the positioning target terminal T according to the present embodiment includes a wireless communicator 4, a sound wave receiver 5, and a positioning calculator 6.

The wireless communicator 4 transmits and receives the information by wirelessly connecting with the external device including the positioning node N. The wireless communicator 4 includes an analog signal processing circuit, a digital signal processing circuit, and an antenna. The wireless communicator 4 has a general function necessary for the wireless communication, such as a connection function and time synchronization function with the external device. The hardware configuration of the wireless communicator 4 is similar to that of the wireless communicator 1 of the positioning node N, and the description is omitted.

The communication standard of the wireless communication between the wireless communicator 4 of the positioning target terminal T and the wireless communicator 1 of the positioning node N is arbitrary. For example, a metropolitan area network (MAN) represented by a cellular communication, a local area network (LAN) represented by a wireless LAN, Bluetooth (registered trademark), or a personal area network (PAN) represented by ZigBee (registered trademark) is used as the communication standard.

The sound wave receiver 5 receives the sound wave transmitted by the positioning node N. More specifically, the sound wave receiver 5 detects the sound wave transmitted by the positioning node N from the received sound waves. When detecting the sound wave transmitted by the positioning node N, the sound wave receiver 5 notifies the positioning calculator 6 that the sound wave transmitted by the positioning node N has been received.

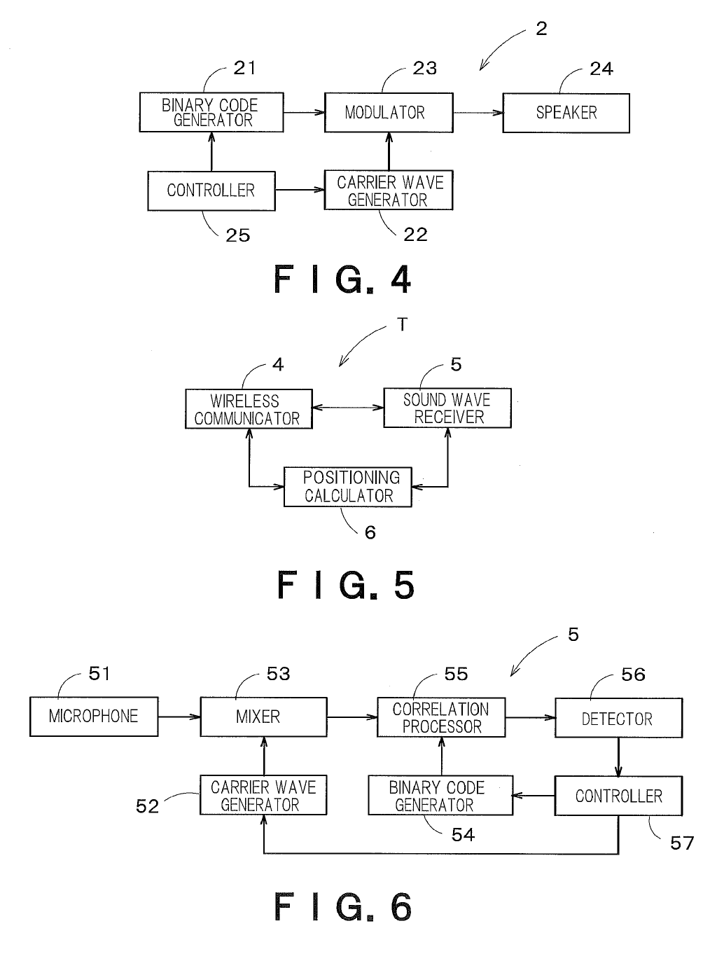

FIG. 6 is a functional block diagram illustrating an example of the sound wave receiver 5. As illustrated in FIG. 6, the sound wave receiver 5 includes a microphone 51, a carrier wave generator 52, a mixer 53, a binary code generator 54, a correlation processor 55, a detector 56, and a controller 57.

The microphone 51 includes a microphone to which the sound wave is input and a bandpass filter. The microphone 51 converts the input sound wave into an electrical signal and outputs the electrical signal.

The carrier wave generator 52 generates a carrier wave to demodulate the signal output by the microphone 51. The frequency, phase, and amplitude of the carrier wave generated by the carrier wave generator 52 are determined according to the carrier wave generated by the carrier wave generator 22 of the positioning node N.

The mixer 53 multiplies the signal output by the microphone 51 and the carrier wave generated by the carrier wave generator 52. When the sound wave transmitted by the positioning node N is input to the microphone 51, the binary code sequence of the positioning node N is demodulated.

The binary code generator 54 generates a binary code sequence to detect the sound wave from the positioning node N. The binary code sequence is, for example, a pseudo-noise sequence known for an M-sequence. When each positioning node N transmits a unique binary code sequence, the binary code generator 54 generates a unique binary code sequence for each positioning node N. The positioning target terminal T may store a unique pseudo-noise sequence of each positioning node N in advance, or may collect the unique pseudo-noise sequence in collection processing of basic information, which will be described later.

Furthermore, when the positioning nodes N transmit a common binary code sequence, the binary code generator 54 may generate the common binary code sequence. The positioning target terminal T may store the common binary code sequence in advance or may collect the common binary code sequence in the collection processing of the basic information.

The correlation processor 55 performs correlation processing between the binary code sequence demodulated by the mixer 53 and the binary code sequence of each positioning node N generated by the binary code generator 54. The correlation processor 55 outputs a correlation value obtained in the correlation processing.

The detector 56 acquires the correlation value output by the correlation processor 55 and detects the correlation value higher than a predetermined value.

When a certain positioning node N₀ transmits a unique binary code sequence by the sound wave, the correlation value between the binary code sequence demodulated from the sound wave transmitted by the positioning node N₀ and the binary code sequence of the positioning node N₀ generated by the binary code generator 54 is higher than other correlation values.

The other correlation values in the description include the correlation value between the binary code sequence demodulated from the sound wave transmitted by the positioning node N₀ and a binary code sequence of a positioning node other than that of the positioning node N₀ generated by the binary code generator 54 or the correlation value between an arbitrary sound wave other than the sound wave transmitted by the positioning node N₀ and the binary code sequence of each positioning node N generated by the binary code generator 54.

Therefore, by detecting a relatively high correlation value, it is possible to detect that the sound wave from the positioning node N has been received and specify the positioning node N which has transmitted the sound wave. The predetermined value compared with the correlation value is a threshold to detect a relatively high correlation value.

When detecting the correlation value higher than the predetermined value, the detector 56 notifies the controller 57 that the sound wave from the positioning node N has been received and of the identifier of the positioning node N which has transmitted the sound wave. The detector 56 may notify the controller 57 that the sound wave from the positioning node N has been received firstly, and of the identifier of the positioning node N which has transmitted the sound wave thereafter. Thus, it is possible to notify the controller 57 that the sound wave from the positioning node N has been received in a shorter delay time.

The controller 57 exchanges the information between the wireless communicator 4 and the positioning calculator 6 and notifies the carrier wave generator 52 and the binary code generator 54 of the setting information. Specifically, the controller 57 notifies the carrier wave generator 52 of the carrier frequency or the information necessary for the binary code generator 54 to generate the binary code sequence (the identifier of each positioning node N, and the like).

Furthermore, when being notified that the sound wave from the positioning node N has been received by the detector 56, the controller 57 acquires the reception time of the sound wave from the wireless communicator 4. The controller 57 associates the reception time with the identifier of the positioning node N which has transmitted the sound wave and notifies the positioning calculator 6 of the association. In the case where each positioning node N transmits a unique binary code sequence, when the detector 56 detects an sound wave, the identifier of the positioning node N which has transmitted the sound wave can be specified. Consequently, the controller 57 can associate the reception time of the sound wave with the identifier of the positioning node N which has transmitted the sound wave.

On the other hand, in the case where the positioning nodes N transmit a common binary code sequence, even though detector detects the sound wave, it cannot be specified which positioning node N has transmitted the sound wave. In this case, the positioning target terminal T may set the transmission times of the positioning nodes N at different times by a sound wave transmission instruction, which will be described later. Thus, since it can be specified which positioning node N has transmitted the sound wave received at a certain time, the controller 57 can associate the reception time of the sound wave with the identifier of the positioning node N which has transmitted the sound wave.

The positioning calculator 6 acquires the reception time and the identifier of the positioning node N from the sound wave receiver 5. The positioning calculator 6 performs the positioning calculation of the positioning target terminal T based on the acquired reception time and identifier of the positioning node N. In other words, the positioning calculator 6 calculates the position coordinates of the positioning target terminal T.

The positioning calculator 6 acquires, first, the position information of the positioning node N based on the identifier of the positioning node N. The position information of the positioning node N includes the position coordinates of the positioning node N. The positioning calculator 6 may acquire the position information of the positioning node N by referring to, for example, a stored table in which the identifier of each positioning node N is associated with the position information of each positioning node N. Furthermore, the positioning calculator 6 may acquire the position information by requesting the positioning node N of the position information via the wireless communicator 4.

The positioning calculator 6 calculates the relative position of the positioning target terminal T with respect to the positioning node N based on the position coordinates of the positioning node N and the reception time. Here, when it is assumed that the a transmission source positioning node i has the position coordinates (xᵢ, yᵢ, zᵢ), that the transmission time is t₀, that the positioning target terminal T has the position coordinates (x₀, y₀, z₀), and that the reception time is tᵢ, the following relational equation is established.

[Equation 1]

e(tᵢ−t₀)=\sqrt{(xᵢ−x₀)²+(yₜ−y₀)²+(zᵢ−z₀)²} (1)

In the equation (1), c represents the sound speed. Furthermore, (xᵢ, yᵢ, zᵢ) and tᵢ are known. When the transmission time t₀ from each positioning node N is known, or, when the transmission time t₀ of each positioning node N is the same, the positioning calculator 6 can obtain the three-dimensional position coordinates (x₀, y₀, z₀) of the positioning target terminal T by calculating the relative position from three positioning nodes N with the equation (1). In other words, it is possible to position the positioning target terminal T. Furthermore, when the transmission times of the positioning nodes N are different, the equation (1) may be solved using the transmission time t₀ of each positioning node N.

Here, the minimum number of positioning nodes N required to position the positioning target terminal T is referred to as the minimum number of nodes. In the above example, the minimum number of nodes is three. Furthermore, when a one-dimensional position coordinate (any one of x₀, y₀, z₀) of the positioning target terminal T is known, the minimum number of nodes is two. Moreover, when a two-dimensional position coordinates (any two of x₀, y₀, z₀) of the positioning target terminal T are known, the minimum number of nodes is one.

When the positioning target terminal T receives the sound waves from the positioning nodes N more than the minimum number of nodes, the positioning calculator 6 may calculate the position coordinates of the positioning target terminal T using, for example, a least-squares method. Thus, it is possible to minimize the error caused by the time synchronization or processing delay and improve the positioning accuracy.

The above positioning method is an inverse GPS method. In the inverse GPS method, the calculation result corresponding to each positioning node N has been weighted based on the reliability of the reception time. Furthermore, when the positioning nodes N more than the minimum number of nodes are available, the combination of the positioning nodes N has been selected so as to increase the spatial distribution of the positioning node N, and the positioning target terminal T has been positioned from the calculation result corresponding to the selected positioning node N. The positioning calculator 6 according to the present embodiment can perform the positioning calculation by arbitrarily combining these methods.

### Connection Processing and Time Synchronization Processing

Next, the connection processing and the time synchronization processing in the positioning system according to the present embodiment will be described. Note that, the detail operations of the positioning target terminal T and the positioning node N will be described later.

First, the positioning target terminal T forms a network. Hereinafter, it is assumed that the network is a wireless LAN. In this case, the positioning target terminal T acts as a master (access point (AP)) of the wireless LAN.

The positioning target terminal T transmits a beacon to form the network. The beacon may be periodically transmitted at a predetermined time interval, or may be transmitted a predetermined number of times. The beacon includes the identifier of the positioning target terminal T and a network name. The identifier of the positioning target terminal T is, for example, a basic service set identifier (BSSID), and the network is, for example, an SSID. Furthermore, the beacon includes the value of the timer of the positioning target terminal T as the time information.

When receiving an authentication request from the positioning node N, the positioning target terminal T transmits a response to the authentication request. Furthermore, the positioning target terminal T transmits an authentication request to the positioning node N and receives the response to the authentication request. Moreover, the positioning target terminal T exchanges association requests with the positioning node N and stores the identifier of the positioning node N. Thus, the positioning target terminal T is being connected with the positioning node N, and the network is formed.

On the other hand, the positioning node N joins the network formed by the positioning target terminal T. The positioning node N acts as a slave (station (STA)) of the wireless LAN.

The positioning node N searches for, first, the network (performs channel scanning). The positioning node N refers to, by the channel scanning, the identifier of the positioning target terminal T and the network name which are included in the beacon, and detects the network formed by the positioning target terminal T and having a preset identifier or network name. When detecting the network, the positioning node N exchanges messages, such as an authentication request, a response, and an association request, with the positioning target terminal T as described above. Thus, the positioning node N is being connected with the positioning target terminal T and joins the network.

After joining the network, the positioning node N stores the identifier of the positioning target terminal T. Furthermore, after joining the network, the positioning node N extracts the time information included in the beacon transmitted by the positioning target terminal T using a timing synchronization function (TSF) of the wireless LAN, and updates the time information of the own node. Thus, the time of the positioning node N is synchronized with the time of the positioning target terminal T. In other words, in the present embodiment, the positioning target terminal T acts as a master of the time synchronization, and the positioning node N acts as a slave of the time synchronization. The master is a reference terminal of the time synchronization. The slave is a terminal to be synchronized with the time of the master.

Note that, the positioning node N preferably performs the time synchronization processing by hardware. This is because that the time synchronization accuracy based on the positioning node N affects the positioning accuracy. By performing the time synchronization processing by hardware, it is possible to improve the time synchronization accuracy, and thereby improve the positioning accuracy. In the wireless LAN, the processing is normally performed by hardware as the processing of the MAC layer, or may be performed by the IC for the time synchronization.

Furthermore, although the wireless LAN operates in an infrastructure mode in the above description, the wireless LAN may operate in an ad hoc mode. In this case, the positioning target terminal T and the positioning node N each perform both the above described operations of master and slave.

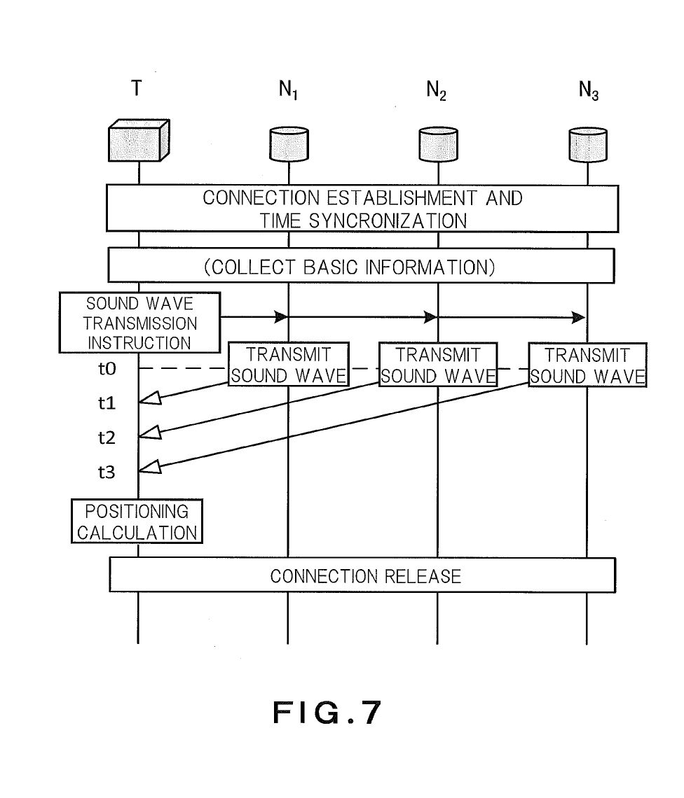

Here, the processing in the positioning system will be described in detail with reference to FIG. 7. FIG. 7 is a sequence diagram illustrating the processing in the positioning system including the positioning target terminal T and the positioning nodes N₁ to N₃.

First, as illustrated in FIG. 7, the positioning target terminal T and the positioning nodes N₁ to N₃ perform the above described connection processing and time synchronization processing. Thus, the network in which the times of the positioning nodes N₁ to N₃ are synchronized with the time of the positioning target terminal T is formed. The positioning target terminal T stores the identifiers of the positioning nodes N₁ to N₃.

Next, the collection processing of the basic information is performed. Specifically, the positioning target terminal T collects the basic information of the positioning nodes N₁ to N₃. The basic information includes, for example, the carrier wave frequency, position information, binary code sequence, and identifier of each of the positioning nodes N₁ to N₃.

The collection processing of the basic information may be performed by requesting, by the positioning target terminal T, the positioning nodes N₁ to N₃ of the basic information. Furthermore, the collection processing of the basic information may be performed by transmitting, by the positioning nodes N₁ to N₃, the basic information of the own node to the positioning target terminal T after the connection processing.

Note that, the collection processing of the basic information can be omitted when the positioning target terminal T has been stored the basic information of the positioning nodes N₁ to N₃.

Next, the positioning target terminal T transmits the sound wave transmission instruction to the positioning nodes N₁ to N₃. The sound wave transmission instruction includes the transmission time t₀ when the positioning nodes N₁ to N₃ transmit the sound wave.

When the transmission time t₀ comes, the positioning nodes N₁ to N₃ each transmit the sound wave. The sound wave includes the identifiers of the positioning nodes N₁ to N₃. Note that, although the transmission times t₀ of the positioning nodes N₁ to N₃ are fixed in the example of FIG. 7, different transmission times may be specified. When the different transmission times are specified, the positioning target terminal T can associate the sound wave with the positioning node N based on the specified transmission time. Therefore, the positioning nodes N₁ to N₃ may transmit the common binary code sequence instead of the unique binary code sequence.

The positioning target terminal T continues the reception processing of the sound wave after the transmission time t₀ until a sound wave acceptance condition is satisfied. In the example of FIG. 7, the sound waves transmitted by the positioning nodes N₁, N₂, and N₃ are received by the positioning target terminal T at the reception times t₁, t₂, and t₃ respectively. Note that, the sound wave acceptance condition will be described later.

Here, the operations of the positioning target terminal T when the sound wave is received will be described. For example, when the sound wave is input to the microphone 51 at the reception time t₁, the microphone 51 converts the sound wave into the electrical signal and outputs the electrical signal. Next, the mixer 53 multiplies the signal output by the microphone 51 and the carrier wave generated by the carrier wave generator 52 and generates the binary code sequence. The positioning target terminal T can associate the received binary code sequence with the positioning node N by any of the above described methods.

Then, the correlation processor 55 performs the correlation processing between the binary code sequence generated by the mixer 53 and the binary code sequence of each of the positioning nodes N₁ to N₃ generated by the binary code generator 54. As described above, the binary code sequence of each of the positioning nodes N₁ to N₃ generated by the binary code generator 54 may be stored in the positioning target terminal T in advance or may be collected in the collection processing of the basic information.

As a result of the correlation processing, the correlation value between the binary code sequence generated by the mixer 53 and the binary code sequence of the positioning node N₁ generated by the binary code generator 54 is higher than the predetermined value. Therefore, the detector 56 notifies the controller 57 that the sound wave has been received from the positioning node N₁.

When being notified that the sound wave has been received by the positioning node N₁, the controller 57 acquires the reception time t₁ from the wireless communicator 4. Then, the controller 57 notifies the positioning calculator 6 of the reception time t₁ and the identifier of the positioning node N₁.

Thereafter, similar processing for the reception time t₂ and t₃ is performed. With the above described processing, the positioning calculator 6 can acquire the reception times t₁ to t₃ and the positioning nodes N₁ to N₃ until the reception processing is terminated.

When the reception processing is terminated, the positioning calculator 6 performs the positioning calculation of the positioning target terminal T based on the reception times t₁ to t₃ and the positioning nodes N₁ to N₃ which are notified by the controller 57. The calculation method is as described above. In the example of FIG. 7, since the transmission time t₀ is known, the minimum number of nodes necessary to calculate the three-dimensional position coordinates of the positioning target terminal T is three. Note that, the positioning calculator 6 may perform, as necessary, the positioning calculation using the transmission time t₀ of each positioning node N.

After the positioning calculation, the connection between the positioning target terminal T and the positioning nodes N₁ to N₃ is released. The connection may be released by transmitting a message to release the authentication or connection by the positioning target terminal T. Thus, it is possible to quickly release the connection and reduce the power consumption.

Furthermore, in the wireless LAN, when the slave cannot receive the beacon for a certain period of time, the connection is generally released. Accordingly, the connection may be released by stopping the transmission of the beacon by the positioning target terminal T. Thus, even when the positioning node N cannot receive the message to release the connection, it is possible to release the connection and reduce the power consumption.

In the conventional positioning system, a particular positioning node N has acted as the master of the time synchronization, and the positioning target terminal T has been the slave of the time synchronization. Consequently, the positionable range is limited to the communicable range of the particular positioning node N which is the master.

In contrast, in the positioning system according to in the present embodiment, the positioning target terminal T becomes the master of the time synchronization, and a certain positioning node N becomes the slave of the time synchronization. Consequently, the positionable range is the range where the positioning target terminal T can be connected with the positioning nodes N of the minimum number of nodes regardless of the placements of the positioning nodes N. Therefore, with the positioning system according to the present embodiment, it is possible to widen the positionable range.

Furthermore, in the conventional positioning system, it is required to amplify the transmission power of the particular positioning node N which is the master and wiredly connect the particular positioning node N which is the master with another positioning node N in order to widen the positionable range. Consequently, when the positionable range is widened, the power consumption and the laying cost are increased.

In contrast, in the positioning system according to in the present embodiment, when the positionable range is widened, it is only required to amplify the transmission power of the positioning target terminal T, and it is not required to amplify the transmission power of the installed positioning nodes N and wiredly be connected with the positioning nodes N. Therefore, with the positioning system according to in the present embodiment, it is possible to reduce the power consumption and the laying cost.

### Operations of Positioning Target Terminal

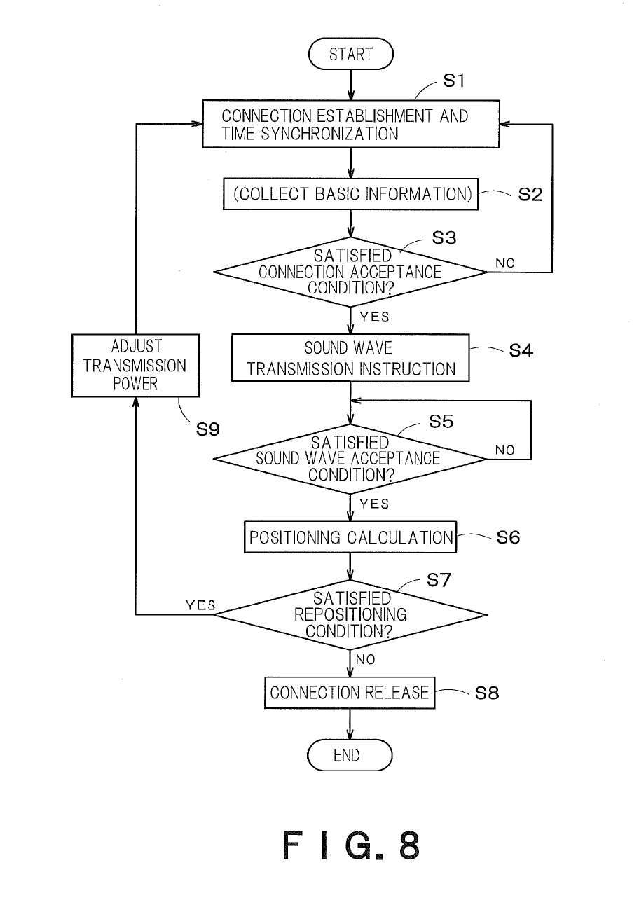

Here, the detail operations of the positioning target terminal T will be described with reference to FIG. 8. FIG. 8 is a flowchart illustrating the operations of the positioning target terminal T.

As illustrated in FIG. 8, when the positioning processing is started, the positioning target terminal T performs the connection processing and the time synchronization processing (step S1). Thus, the network is formed. After forming the network, the positioning target terminal T performs the collection processing of the basic information to the positioning node N being connected (step S2). The connection processing, the time synchronization processing, and the collection processing of the basic information have been described above and the descriptions are omitted.

Next, the positioning target terminal T determines whether a connection acceptance condition has been satisfied (step S3). The connection acceptance condition is the condition to terminate the connection processing. The connection acceptance condition is, for example, but not limited to, that the number of the connected positioning nodes N exceeds the minimum number of nodes or that a certain period of time has elapsed from the start of the connection processing. The certain period of time is preferably set based on the channel scanning rate or the sleep time of the positioning node N.

When the connection acceptance condition has not been satisfied (No in step S3), the processing returns to step S1.

On the other hand, when the connection acceptance condition has been satisfied (Yes in step S3), the positioning target terminal T starts the reception processing of the sound wave and transmits the sound wave transmission instruction to the positioning node N being connected (step S4).

Next, the positioning target terminal T determines whether the sound wave acceptance condition has been satisfied (step S5). The sound wave acceptance condition is the condition to terminate the reception processing of the sound wave. The sound wave acceptance condition is, for example, but not limited to, that the sound wave is received from the positioning nodes N more than the minimum number of nodes or that the certain period of time has elapsed from a predetermined timing. The above predetermined timing is, for example, the transmission time t₀ specified by the sound wave transmission instruction or the timing when the reception processing is started. Furthermore, when the different transmission times t₀ are specified to the positioning nodes N, the predetermined timing may be the latest transmission time t₀.

When the sound wave acceptance condition has not been satisfied (No in step S5), the processing of step S5 is repeated.

On the other hand, when the sound wave acceptance condition has been satisfied (Yes in step S5), the positioning target terminal T terminates the reception processing of the sound wave and performs the positioning calculation (step S6). The positioning calculation has been described above and the description is omitted.

After the positioning calculation, the positioning target terminal T determines whether a repositioning condition has been satisfied (step S7). The repositioning condition is the condition to determine that repositioning is performed. The repositioning condition is, for example, but not limited to, that the result of the positioning calculation is an abnormal value, or that the number of positioning nodes N transmitting the sound wave which the positioning target terminal T has received is less than the minimum number of nodes in the reception processing.

The reason to determine that the number of positioning nodes N transmitting the sound wave which the positioning target terminal T has received is because the sound wave reaching distance is different from the electric wave reaching distance and the number of positioning nodes N connected with the positioning target terminal T does not necessarily correspond to the number of positioning nodes N transmitting the sound wave which the positioning target terminal T can receive.

When the repositioning condition is not satisfied (No in step S7), the positioning target terminal T releases the connection with the positioning node N (step S8). Thus, the positioning processing is terminated.

On the other hand, when the repositioning condition has been satisfied (Yes in step S9), the positioning target terminal T performs the adjustment processing of the transmission power (step S9). The transmission power in the description is, for example, the transmission power of the beacon. Thereafter, the processing returns to step S1.

The positioning target terminal T, for example, raises the transmission power level by one by the adjustment processing of the transmission power. Thus, it is possible to increase the number of connectable positioning nodes N in the connection processing of step S1.

Note that, when the sound wave cannot be received from the positioning nodes less than the minimum number of nodes even though the positioning nodes N more than the minimum number of nodes are connected, the positioning target terminal T can transmit, to the positioning nodes N transmitting the sound wave which the positioning target terminal T has not received, a message to amplify the transmission power (volume) of the sound wave in the adjustment processing of the transmission power. The power supply controller 3 of the positioning node N only requires to receive the message via the wireless communicator 1 and adjust the power supplied to the sound wave transmitter 2.

Furthermore, instead of performing the positioning processing while the transmission power level is being raised one by one in the adjustment processing of the transmission power as described above, the adjustment processing of the transmission power can be performed before the connection processing. In this case, the positioning target terminal T investigates the positioning node N transmitting the sound wave which the positioning target terminal T can receive while raising the transmission power level one by one in the adjustment processing of the transmission power. Then, the positioning target terminal T determines, as the transmission power of the beacon, the minimum transmission power which does not further increase the number of positioning nodes N transmitting the sound wave which the positioning target terminal T can receive. Thereafter, the positioning target terminal T is only required to perform the processing from step S1 to S8.

### Operations of Positioning Node

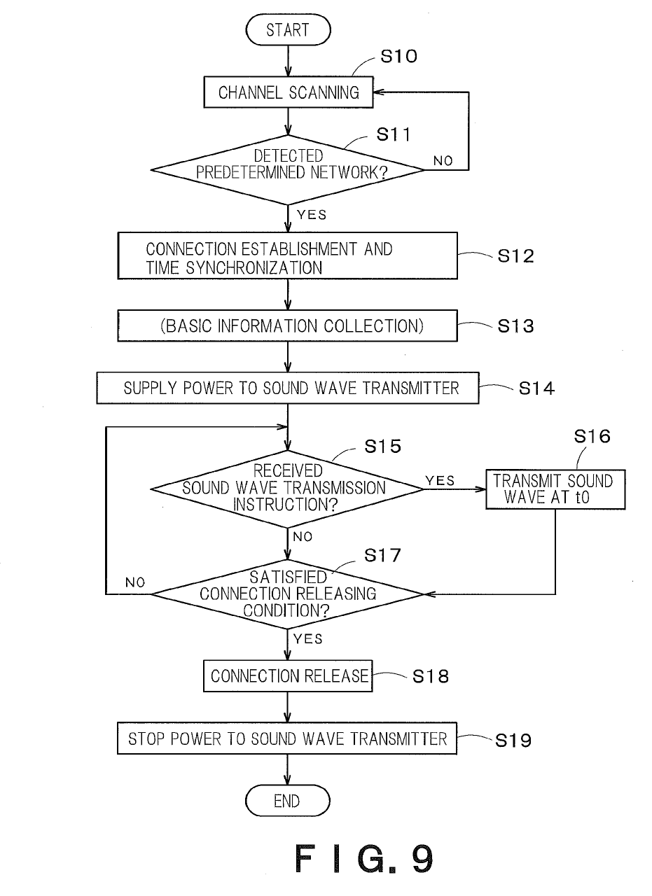

Next, the detail operations of the positioning node N will be described with reference to FIG. 9. FIG. 9 is a flowchart illustrating the operations of the positioning node N.

First, the positioning node N performs the channel scanning and searches for a predetermined network (step S10). The predetermined network is the network formed by the positioning target terminal T. The positioning node N can search for the predetermined network by referring to the identifier of the positioning target terminal T included in the beacon. Note that, during performing the channel scanning, the power of the sound wave transmitter 2 is stopped by the power supply controller 3.

Next, the positioning node N determines whether the predetermined network has been detected by the channel scanning (step S11). When the predetermined network has not been detected (No in step S11), the processing returns to step S10.

On the other hand, when the predetermined network has been detected (Yes in step S11), the positioning node N performs the connection processing and the time synchronization processing (step S12) and joins the network formed by the positioning target terminal T. After joining the network, the positioning node N performs the collection processing of the basic information in the connected positioning target terminal T (step S13). Note that, the connection processing, the synchronization processing, and the collection processing of the basic information have been described above and the descriptions are omitted.

When the positioning node N is connected with the positioning target terminal T, the power supply controller 3 supplies the power to the sound wave transmitter 2 (step S14). In other words, the power supply controller 3 functions as a low power consumption starting circuit of the positioning node N. Note that, the order of the power supply to the sound wave transmitter 2 and the collection processing of the basic information may be reversed.

Next, the positioning node N determines whether the sound wave transmission instruction has been received from the positioning target terminal T (step S15). When the sound wave transmission instruction has not been received, the processing proceeds to step S17.

On the other hand, when the sound wave transmission instruction has been received (Yes in step S15), the positioning node N transmits the sound wave at the transmission time t₀ specified by the sound wave transmission instruction (step S16).

Thereafter, the positioning node N determines whether the connection releasing condition has been satisfied (step S17). The connection releasing condition is the condition to terminate the connection with the positioning target terminal T. The connection releasing condition is, for example, but not limited to, that the message to release the connection is received from the positioning target terminal T or that the beacon cannot be received from the positioning target terminal T for a certain period of time.

When the connection releasing condition has not been satisfied (No in step S17), the processing returns to step S15.

On the other hand, when the connection releasing condition has been satisfied (Yes in step S17), the positioning node N releases the connection with the positioning target terminal T (step S18).

Thereafter, the power supply controller 3 stops the power of the sound wave transmitter 2 (step S19). After that, the positioning node N performs the channel scanning until the predetermined network is detected.

As described above, in the positioning node N according to the present embodiment, the power supply controller 3 functions as the low power consumption starting circuit. Since the power is supplied to the sound wave transmitter 2 while the positioning node N is being connected with the positioning target terminal T, it is possible to reduce the power consumption of the positioning node N.

Note that, although the power is supplied to the sound wave transmitter 2 after being connected with the positioning target terminal T in the above description, the power may be supplied after receiving the sound wave transmission instruction. Thus, it is possible to further shorten the time to supply the power to the sound wave transmitter 2 and reduce the power consumption.

Furthermore, the positioning node N may alternately repeat the channel scanning and the sleep at a predetermined time interval after releasing the connection with the positioning target terminal T. Thus, it is possible to further reduce the power consumption. In this case, it is preferable that the connection acceptance condition of the positioning target terminal T is set considering the sleep time of the positioning node N. Specifically, it is preferable that a certain period of time after the connection starting processing to terminate the connection processing is longer than the sleep time. Thus, it is possible to avoid the problem that the connection cannot be performed due to the sleep time of the positioning node N.

### Second Embodiment

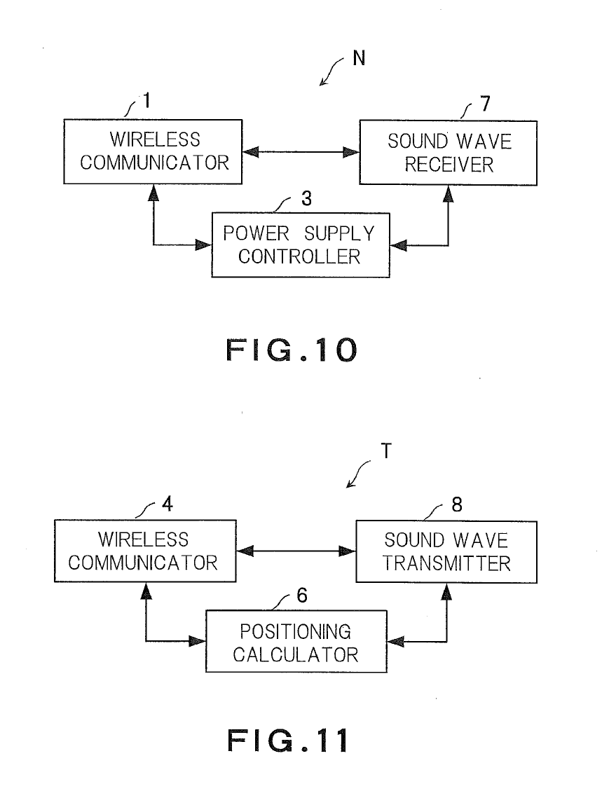

A positioning system according to a second embodiment will be described with reference to FIGS. 10 to 14. The positioning system according to the present embodiment includes, similarly to the first embodiment, a positioning target terminal T and a plurality of positioning nodes N.

FIG. 10 is a block diagram illustrating a functional configuration of the positioning node N according to the present embodiment. As illustrated in FIG. 10, the positioning node N according to the present embodiment includes a wireless communicator 1, a sound wave receiver 7, and a power supply controller 3. The sound wave receiver 7 is equivalent to the sound wave receiver 5 in the first embodiment.

FIG. 11 is a block diagram illustrating a functional configuration of the positioning target terminal T according to the present embodiment. As illustrated in FIG. 11, the positioning target terminal T according to the present embodiment includes a wireless communicator 4, a sound wave transmitter 8, and a positioning calculator 6. The sound wave transmitter 8 is equivalent to the sound wave transmitter 2 in the first embodiment.

In the present embodiment, the positioning target terminal T transmits an sound wave from the sound wave transmitter 8, and the positioning node N receives the sound wave at the sound wave receiver 7. The other configurations are similar to those in the first embodiment.

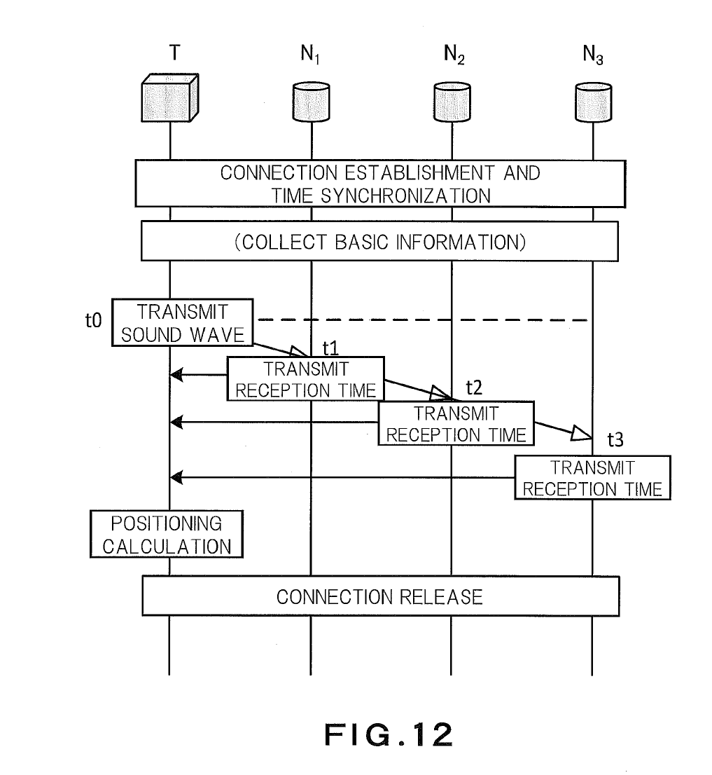

Here, the processing in the positioning system according to the present embodiment will be described in detail with reference to FIG. 12. FIG. 12 is a sequence diagram illustrating the processing in the positioning system including the positioning target terminal T and positioning nodes N₁ to N₃.

First, connection processing, time synchronization processing, and collection processing of basic information are performed as illustrated in FIG. 12. This is similar to that in the first embodiment.

Next, the positioning target terminal T transmits the sound wave from the sound wave transmitter 8. In the present embodiment, the sound wave is transmitted by the positioning target terminal T, and the sound wave transmission instruction is unnecessary. Furthermore, the time when the sound wave transmitter 8 has transmitted the sound wave is a transmission time t₀.

After the positioning target terminal T transmits the sound wave, each of the positioning nodes N₁ to N₃ receives the sound wave at the corresponding sound wave receiver 7 and acquires the reception time. In the example of FIG. 12, the reception times of the positioning nodes N₁, N₂, and N₃ are t₁, t₂, and t₃ respectively.

Then, the positioning nodes N₁ to N₃ each transmit the reception times t₁ to t₃ respectively to the positioning target terminal T. The positioning nodes N₁ to N₃ may transmit the position information of the own node together with the reception time.

The positioning target terminal T performs the positioning calculation of the positioning target terminal T based on the reception times t₁ to t₃ and the position information of the positioning nodes N₁ to N₃ which are each received from the positioning nodes N₁ to N₃ respectively. Thereafter, the connection between the positioning target terminal T and the positioning node N is released.

### Operations of Positioning Target Terminal

Here, the detail operations of the positioning target terminal T will be described with reference to FIG. 13. FIG. 13 is a flowchart illustrating the operations of the positioning target terminal T. The processing of steps S1 to S3 and S6 to S9 in FIG. 13 is similar to those in the first embodiment. Hereinafter, steps S20 and S21 which are different from the first embodiment will be described.

In the present embodiment, when the connection acceptance condition has been satisfied (Yes in step S3), the positioning target terminal T transmits the sound wave (step S20). In the present embodiment, since the transmission source is the positioning target terminal T alone, a binary code sequence transmitted by sound wave does not require to include the detailed information on the transmission source. Consequently, a specified pseudo-noise sequence can be used as the binary code sequence. After transmitting the sound wave, the positioning target terminal T performs the acceptance processing of the reception time from the positioning node N.

Next, the positioning target terminal T determines whether the reception time acceptance condition has been satisfied (step S21). The reception time acceptance condition is the condition to terminate the acceptance processing of the reception time. The reception time acceptance condition is, for example, but not limited to, that the reception time is received from the positioning nodes N more than the minimum number of nodes or that a certain period of time has elapsed from the transmission time t₀.

When the reception time acceptance condition has not been satisfied (No in step S21), the processing of step S21 is repeated.

On the other hand, when the reception time acceptance condition has been satisfied (Yes in step S21), the positioning target terminal T terminates the reception processing of the reception time and performs the positioning calculation(step S6). The subsequent processing is similar to that in the first embodiment.

### Operations of Positioning Node

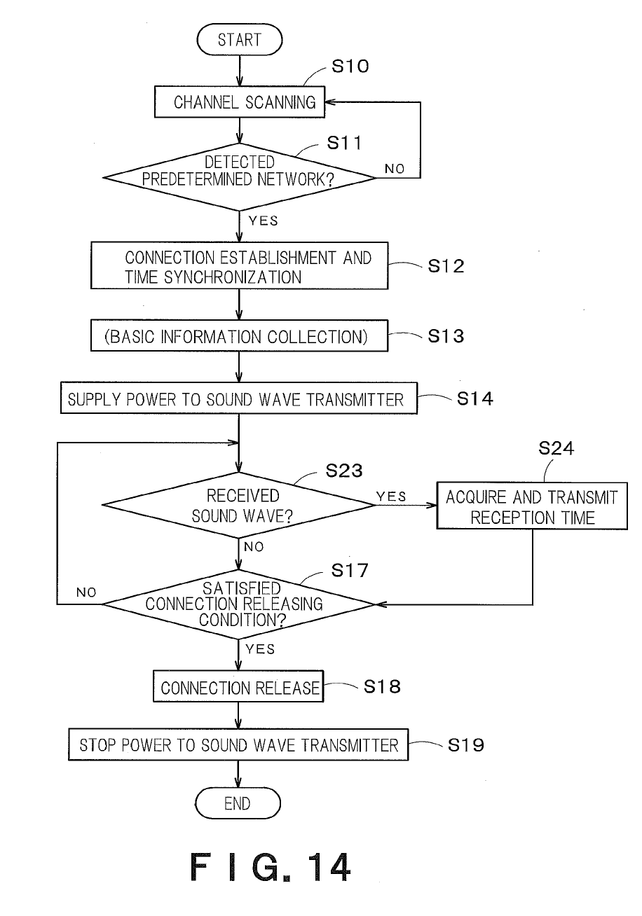

Next, the detail operations of the positioning node N will be described with reference to FIG. 14. FIG. 14 is a flowchart illustrating the operations of the positioning node N. The processing of steps S10 to S14 and S17 to S19 in FIG. 14 is similar to those in the first embodiment.

However, in the present embodiment, the power supply controller 3 supplies the power to the sound wave transmitter 8 in step S14. Furthermore, the power supply controller 3 stops the power of the sound wave transmitter 8 in step S19. Hereinafter, steps S23 and S24 which are different from the first embodiment will be described.

In the present embodiment, when the power supply controller 3 supplies the power to the sound wave transmitter 8, the positioning node N starts performing the reception processing of the sound wave. Then, the positioning node N determines whether the sound wave transmitted by the positioning target terminal T has been detected (step S23). The positioning node N can determine whether the sound wave has been detected by comparing the pseudo-noise sequence included in the sound wave with the pseudo-noise sequence stored in the own node or performing the correlation processing.

When the sound wave has not been received (No in step S23), the processing proceeds to step S17.

On the other hand, when the sound wave has been received (Yes in step S23), the positioning node N acquires the reception time when the sound wave is received and transmits the time to the positioning target terminal T (step S24). Thereafter, the processing proceeds to step S17. The subsequent processing is similar to that in the first embodiment.

In the positioning system according to in the present embodiment, the positioning target terminal T becomes a master of the time synchronization, and the positioning node N becomes a slave of the time synchronization. Therefore, it is possible to widen the positionable range similarly to the first embodiment.

Furthermore, in the positioning node N, since the power supply controller 3 functions as the low power consumption starting circuit and the power is supplied to the sound wave receiver 7 while the positioning node N is being connected with the positioning target terminal T, it is possible to reduce the power consumption of the positioning node N.

### Third Embodiment

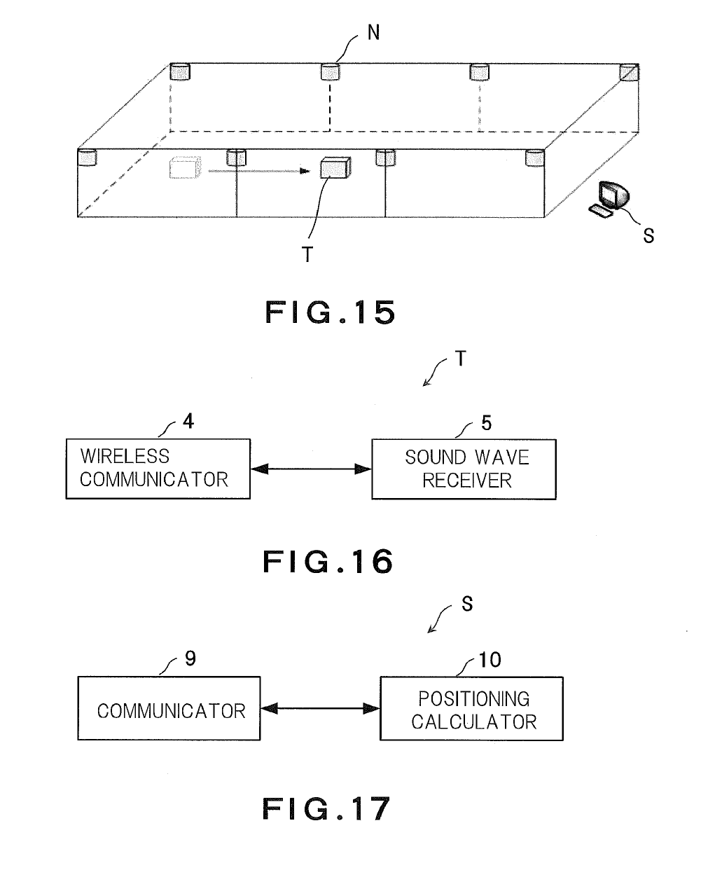

A positioning system according to a third embodiment will be described with reference to FIGS. 15 to 18. In the positioning system according to the present embodiment, a positioning calculation is performed at a positioning server. FIG. 15 is a diagram illustrating the positioning system according to the present embodiment. As illustrated in FIG. 15, the positioning system according to the present embodiment includes a positioning target terminal T, a plurality of positioning nodes N, and a positioning server S. The configuration of the positioning node N is similar to that in the first embodiment.

FIG. 16 is a functional block diagram illustrating an example of the positioning target terminal T according to the present embodiment. As illustrated in FIG. 16, the positioning target terminal T includes a wireless communicator 4 and a sound wave receiver 5. The wireless communicator 4 and the sound wave receiver 5 are similar to those in the first embodiment. However, in the present embodiment, the wireless communicator 4 includes a wireless communication function with the positioning server S, in addition to a wireless communication function with the wireless communicator 1 of the positioning node N.

FIG. 17 is a functional block diagram illustrating an example of the positioning server S. As illustrated in FIG. 17, the positioning server S includes a communicator 9 and a positioning calculator 10. The positioning calculator 10 is equivalent to the positioning calculator 6 in the first embodiment.

The communicator 9 transmits and receives information by wirelessly or wiredly connecting with an external device including the positioning target terminal T. The communicator 9 includes an analog signal processing circuit, a digital signal processing circuit, and an antenna. The communicator 9 has a general function necessary for the wireless communication, such as a connection function and time synchronization function with the external device.

In the positioning system according to in the present embodiment, the wireless communication is performed between the wireless communicator 4 of the positioning target terminal T and the communicator 9 of the positioning server S. The communication standard of the wireless communication can be arbitrarily selected. For example, a metropolitan area network (MAN) represented by a cellular communication, a local area network (LAN) represented by a wireless LAN, Bluetooth (registered trademark), or a personal area network (PAN) represented by ZigBee (registered trademark) is used as the communication standard.

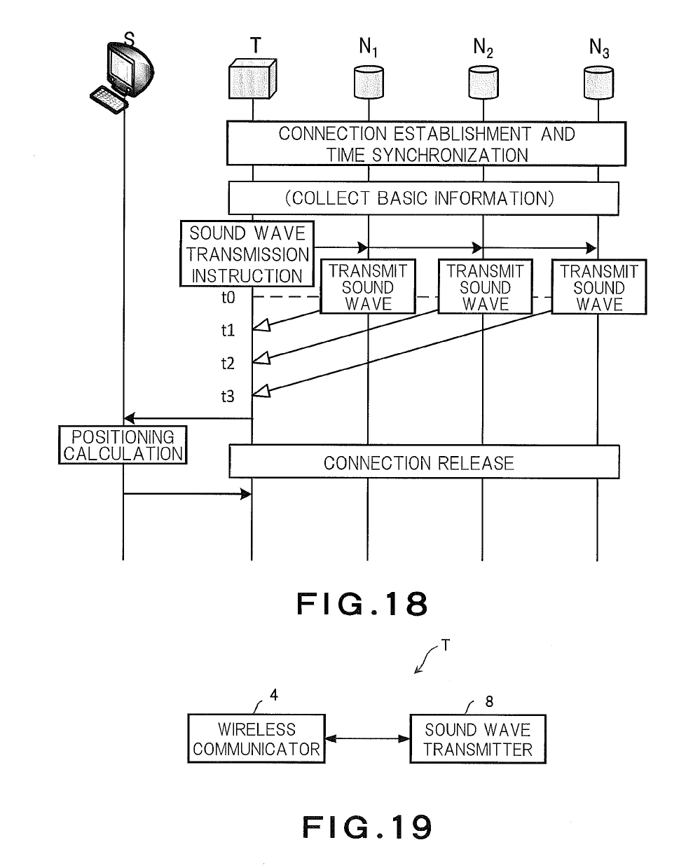

Here, the processing in the positioning system according to the present embodiment will be described in detail with reference to FIG. 18 FIG. 18 is a sequence diagram illustrating the processing in the positioning system including the positioning target terminal T, positioning nodes N₁ to N₃, and the positioning server S.

As illustrated in FIG. 18, the processing until the positioning target terminal T receives the sound waves transmitted by the positioning nodes N₁ to N₃ and acquires the reception times t₁ to t₃ is similar to that in the first embodiment.

In the present embodiment, when acquiring the reception times t₁ to t₃, the positioning target terminal T transmits the reception times t₁ to t₃ and the identifiers of the positioning nodes N₁ to N₃ to the positioning server S. Thereafter, the connection between the positioning target terminal T and the positioning nodes N₁ to N₃ is released.

The positioning server S performs the positioning calculation based on the reception times t₁ to t₃ received from the positioning target terminal T and the identifiers of the positioning nodes N₁ to N₃. At this time, the positioning server S may store the position information of the positioning nodes N₁ to N₃ or may receive the information from the positioning target terminal T. Furthermore, the positioning server S may receive, as necessary, the transmission time t₀ from the positioning target terminal T.

Thereafter, the positioning server S may transmit, to the positioning target terminal T, the result of the positioning calculation or the information according to the result of the positioning calculation. For example, the positioning server S transmits a movement command according to the current position of the positioned positioning target terminal T.

In the positioning system according to in the present embodiment, the positioning target terminal T becomes a master of the time synchronization, and the positioning node N becomes a slave of the time synchronization. Therefore, it is possible to widen the positionable range similarly to the first embodiment.

Furthermore, in the positioning node N, since the power supply controller 3 functions as a low power consumption starting circuit and the power is supplied to the sound wave transmitter 2 while the positioning node N is being connected with the positioning target terminal T, it is possible to reduce the power consumption of the positioning node N.

Note that, although the positioning target terminal T transmits the information to the positioning server S before releasing the connection between the positioning target terminal T and the positioning node N and the positioning server S transmits the information to the positioning target terminal T after releasing the connection between the positioning target terminal T and the positioning node N in the example of FIG. 18, the timing of the transmission can be arbitrarily selected.

Furthermore, in the present embodiment, it is only required to exchange the information between the positioning target terminal T and the positioning server S. Therefore, the positioning target terminal T and the positioning server S are not limited to be wirelessly connected, and may be wiredly connected. In this case, a wired communicator capable of wiredly connecting with the communicator 9 may be provided at the positioning target terminal T.

### Fourth Embodiment

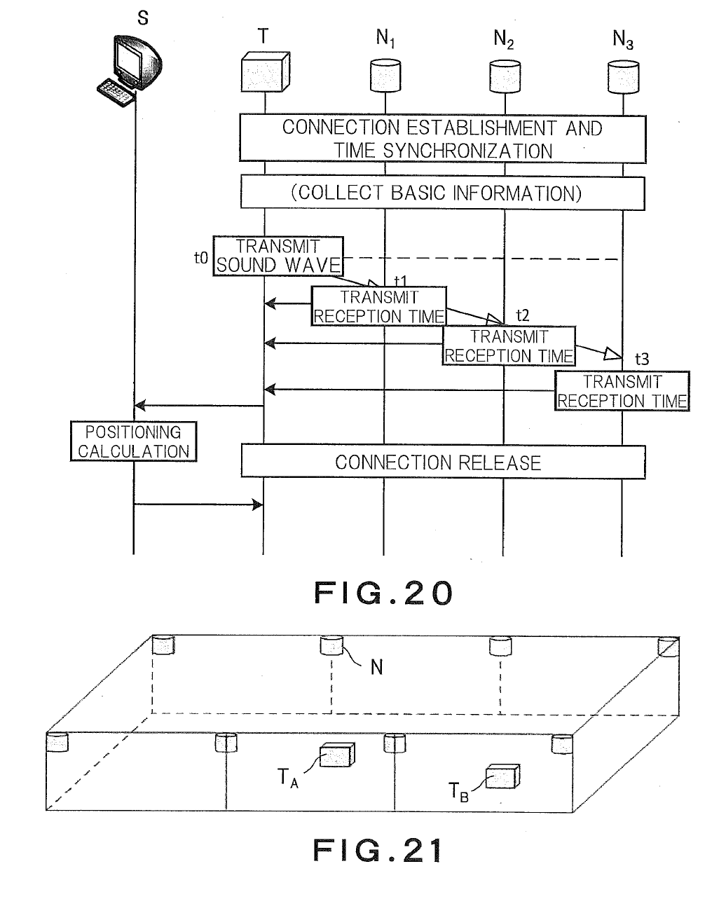

A positioning system according to a fourth embodiment will be described with reference to FIGS. 19 and 20. The positioning system according to the present embodiment is the combination of that in the second embodiment and the third embodiment. In other words, a positioning target terminal T transmits an sound wave, a positioning node N receives the sound wave, and a positioning server S performs a positioning calculation. Consequently, the positioning system according to the present embodiment includes, similarly to the third embodiment, the positioning target terminal T, a plurality of positioning nodes N, and the positioning server S. The configuration of the positioning node N is similar to that in the second embodiment. Furthermore, the configuration of the positioning server S is similar to that in the third embodiment.

FIG. 19 is a functional block diagram illustrating an example of the positioning target terminal T according to the present embodiment. As illustrated in FIG. 20, the positioning target terminal T includes a wireless communicator 4 and a sound wave transmitter 8.

Here, the processing in the positioning system according to the present embodiment will be described in detail with reference to FIG. 20. FIG. 20 is a sequence diagram illustrating processing in the positioning system including the positioning target terminal T, positioning nodes N₁ to N₃, and the positioning server S.

As illustrated in FIG. 20, the processing until the positioning target terminal T receives the reception times t₁ to t₃ each transmitted from the positioning nodes N₁ to N₃ respectively is similar to that in the second embodiment.

In the present embodiment, when receiving the reception times t₁ to t₃, the positioning target terminal T transmits, to the positioning server S, the reception times t₁ to t₃ and the identifiers of the positioning nodes N₁ to N₃. The subsequent processing is similar to that in the third embodiment.

In the positioning system according to in the present embodiment, the positioning target terminal T becomes a master of the time synchronization, and the positioning node N becomes a slave of the time synchronization. Therefore, it is possible to widen the positionable range similarly to the first embodiment.

Furthermore, in the positioning node N, since the power supply controller 3 functions as the low power consumption starting circuit and the power is supplied to the sound wave receiver 7 while the positioning node N is being connected with the positioning target terminal T, it is possible to reduce the power consumption of the positioning node N.

### Fifth Embodiment

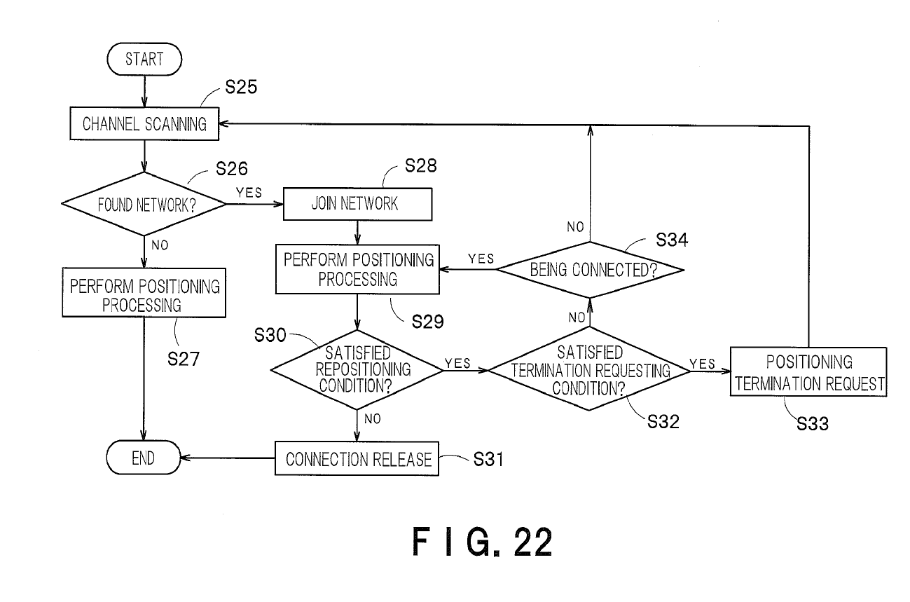

A positioning system according to a fifth embodiment will be described with reference to FIGS. 21 and 22. In the present embodiment, the case in which the positioning system includes a plurality of positioning target terminals T will be described.

FIG. 21 is a diagram illustrating the positioning system according to the present embodiment. As illustrated in FIG. 21, the positioning system according to the present embodiment includes a plurality of positioning nodes N and a plurality of positioning target terminals T. In the example of FIG. 21, although two positioning target terminals T_{A} and T_{B} are illustrated, three or more positioning target terminals T may be included in the positioning system.

Even in the case where the positioning system includes the positioning target terminals T, when each of the positioning target terminals T is separated and the positioning nodes N with which each positioning target terminal T can be connected are different, each positioning target terminal T can perform the above described positioning processing.

However, when the positioning target terminals T are adjacent and the positioning nodes N with which each positioning target terminal T can be connected are overlapped, each positioning target terminal T cannot perform the above described positioning processing. This is because the time of the overlapped the positioning node N cannot be synchronized with the times of the positioning target terminals T.

In the present embodiment, the positioning processing of each positioning target terminal T in this case will be described. Hereinafter, it is assumed that the positioning system includes the two positioning target terminals T_{A} and T_{B} and that a part of or all of the positioning nodes N with which the positioning target terminals T_{A} and T_{B} can be connected are overlapped.

As a method for performing the positioning processing of the positioning target terminals T_{A} and T_{B}, it is considered that the timings when the positioning target terminals T_{A} and T_{B} each perform the positioning processing are shifted. Specifically, the positioning target terminal T_{A} forms the network, performs the positioning calculation, and releases the connection. Then, the positioning target terminal T_{B} forms the network, performs the positioning calculation, and releases the connection. Thereafter, the similar processing is repeated.

With the method, the positioning target terminal T_{A} and T_{B} can each perform the positioning processing. This is because that the positioning target terminals T_{A} and T_{B} release the connection with the positioning node N after the positioning processing, and each positioning node N is thereby continuously connected only with a certain positioning target terminal T. The timing of the positioning processing of each of the positioning target terminals T_{A} and T_{B} may be set in advance or may be determined based on the communication between the positioning target terminals T_{A} and T_{B}.

Furthermore, as another method for performing the positioning processing of the positioning target terminals T_{A} and T_{B}, the method illustrated in FIG. 22 is considered. FIG. 22 is a flowchart illustrating the operations of each positioning target terminal T. The following will be described as the operations of the positioning target terminal T_{A}. Furthermore, it is assumed that the positioning processing is performed by transmitting the sound wave by the positioning node N and receiving the sound wave by the positioning target terminals T_{A} and T_{B} similarly to that in the first embodiment.

First, the positioning target terminal T_{A} performs channel scanning and searches for a network formed by another positioning target terminal T_{B} (step S25).

When the network by the positioning target terminal T_{B} has not been found (No in step S26), the positioning target terminal T_{A} performs the positioning processing (step S27). The positioning processing in step S27 is similar to that in the first embodiment. In other words, the positioning target terminal T_{A} is connected with the positioning node N, receives the sound wave, performs the positioning calculation, and releases the connection with the positioning node N.

On the other hand, when the network by the positioning target terminal T_{B} has been found (Yes in step S26), the positioning target terminal T_{A} connects with the positioning target terminal T_{B} and joins the network formed by the positioning target terminal T_{B} (step S28). In the network, the positioning target terminal T_{B} acts as a master, and the positioning target terminal T_{A} acts as a slave.

When joining the network, the positioning target terminal T_{A} may be or may not be synchronized with the time of the positioning target terminal T_{B}. Furthermore, when joining the network, the positioning target terminal T_{A} preferably notifies the positioning target terminal T_{B} that the positioning target terminal T_{A} itself is not the positioning node N. Thus, the positioning target terminal T_{B} can correctly grasp the number of positioning nodes N being connected.

After joining the network, the positioning target terminal T_{A} acquires, from the positioning target terminal T_{B}, the information on the positioning node N joining the network (the identifier or position information of the positioning node N). Furthermore, the positioning target terminal T_{A} may acquire a transmission time t₀ of each positioning node N specified by a sound wave transmission instruction as necessary.

Thereafter, the positioning target terminal T_{A} performs the positioning processing according to the positioning processing of the positioning target terminal T_{B} (step S29). In other words, the positioning target terminal T_{A} receives the sound wave from each positioning node N in response to the sound wave transmission instruction transmitted by the positioning target terminal T_{B} and acquires the reception time and the identifier of each positioning node N. Then, the positioning target terminal T_{A} performs the positioning processing based on the reception time and the identifier of each of the positioning node N which are acquired in this manner. In the positioning processing of step S29, that the time of each positioning node N is synchronized with the time of the positioning target terminal T_{B} instead of the positioning target terminal T_{A} is different from the positioning processing of step S27.

After the positioning calculation, the positioning target terminal T_{A} determines whether a repositioning condition has been satisfied (step S30). When the repositioning condition has not been satisfied (No in step S30), the positioning target terminal T_{A} releases the connection with the positioning target terminal T_{B} (step S31). Thus, the positioning processing of the positioning target terminal T_{A} is terminated.

On the other hand, when the repositioning condition has been satisfied (Yes in step S30), the positioning target terminal T_{A} determines whether a termination requesting condition has been satisfied (step S32). The termination requesting condition is the condition to determine whether the positioning target terminal T_{B} terminates the positioning processing. The termination requesting condition is, for example, but not limited to, that the positioning processing of the positioning target terminal T_{A} is not succeeded a predetermined number of times or more, or that the positioning processing is not succeeded for a predetermined period of time or longer. The case where the positioning processing is not succeeded includes the case where the result obtained by the positioning calculation is an abnormal value or the case where the sound wave from the positioning node N more than the minimum number of nodes cannot be received.

When the termination requesting condition has been satisfied (Yes in step S32), the positioning target terminal T_{A} transmits a positioning termination request to the positioning target terminal T_{B} (step S33). Thereafter, the processing returns to step S25.

When the positioning target terminal T_{B} has replied to the positioning termination request, the positioning target terminal T_{B} terminates the positioning processing, and the connection with the positioning node N is released. Consequently, the network by the positioning target terminal T_{B} cannot be found by the channel scanning (No in step S26). Therefore, the positioning target terminal T_{A} can form the network where the positioning target terminal T_{A} itself is the master and perform the positioning processing (step S27).

On the other hand, the positioning target terminal T_{B} has not replied to the positioning termination request, the network formed by the positioning target terminal T_{B} is found again by the channel scanning (No in step S26). Consequently, the positioning target terminal T_{A} repeats the processing after step S28.

Furthermore, when the termination requesting condition has not been satisfied (No in step S32), the positioning target terminal T_{A} checks whether the network by the positioning target terminal T_{B} has been connected (step S34). When the network has been connected at the time of checking (Yes in step S34), in other words, when the network by the positioning target terminal T_{B} has been formed, the processing returns to step S29.

On the other hand, when the network has not been connected at the time of checking (No in step S34), in other words, when the connection of the network by the positioning target terminal T_{B} has been released, the processing returns to step S25. At this time, since the network by the positioning target terminal T_{B} has been released, the network by the positioning target terminal T_{B} is not found by the channel scanning (No in step S26). Therefore, the positioning target terminal T_{A} can form the network where the positioning target terminal T_{A} itself is the master and perform the positioning processing (step S27).

With the above described method, even when the positioning system includes the positioning target terminals T, the positioning processing of each positioning target terminal T can be performed. Furthermore, in the present embodiment, since the positioning target terminal T becomes the master of the time synchronization, it is possible to widen the positionable range similarly to the first embodiment.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A positioning target terminal comprising:
a wireless communicator having a connection function and time synchronization function with a positioning node and acting as a master of time synchronization; and
a positioning calculator to perform a positioning calculation based on a reception time of a sound wave transmitted from the positioning node or a reception time of a sound wave received by the positioning node.

2. The terminal according to claim 1 further comprising:
a sound wave receiver to receive the sound wave from the positioning node, wherein
the positioning calculator performs the positioning calculation based on a reception time when the sound wave receiver receives the sound wave.

3. The terminal according to claim 2, wherein when being connected with more than a predetermined number of the positioning node, the wireless communicator transmits a sound wave transmission instruction to cause the positioning node being connected to transmit the sound wave.

4. The terminal according to claim 1 further comprising:
a sound wave transmitter to transmit the sound wave to the positioning node, wherein
the positioning calculator performs the positioning calculation based on a reception time when the positioning node receives the sound wave transmitted by the sound wave transmitter.

5. The terminal according to claim 4, wherein after transmitting the sound wave, the sound wave transmitter receives the reception time from the positioning node being connected.

6. The terminal according to claim 1, wherein when a repositioning condition has been satisfied after the positioning calculation, a transmission power of the wireless communicator is adjusted.

7. The terminal according to claim 1, wherein when a repositioning condition has not been satisfied after the positioning calculation, the connection between the wireless communicator and the positioning node is released.

8. The terminal according to claim 1, wherein the wireless communicator searches for a network formed by another terminal by channel scanning.

9. The terminal according to claim 8, wherein when the network has been found, the wireless communicator is connected with the another terminal.

10. The terminal according to claim 8, wherein when the network has not been found, the wireless communicator is connected with the positioning node.

11. A positioning node comprising:
a wireless communicator having a connection function and time synchronization function with a positioning target terminal and acting as a slave of time synchronization; and
a power supply controller to control a power to transmit and receive a sound wave to and from the positioning target terminal.

12. The node according to claim 11 further comprising:
a sound wave transmitter to transmit the sound wave to the positioning target terminal, wherein
the sound wave transmitter transmits the sound wave at a transmission time specified by a sound wave transmission instruction received from the positioning target terminal.

13. The node according to claim 11 further comprising:
a sound wave receiver to receive the sound wave from the positioning target terminal, wherein
the wireless communicator transmits, to the positioning target terminal, a reception time when the sound wave receiver receives the sound wave.

14. The node according to claim 12, wherein the power supply controller supplies and stops the power to the sound wave transmitter or the sound wave receiver.

15. The node according to claim 12, wherein after the wireless communicator is connected with the positioning target terminal, the power supply controller supplies the power to the sound wave transmitter or the sound wave receiver.

16. The node according to claim 12, wherein after the connection between the wireless communicator and the positioning target terminal is released, the power supply controller stops the power supplied to the sound wave transmitter or the sound wave receiver.

17. A positioning system comprising:
the terminal according to claim 1; and
the node according to claim 11.

18. A positioning system comprising:
a positioning target terminal having a connection function and time synchronization function with a positioning node, comprising a wireless communicator which acts as a master of time synchronization, and to transmit and receive a sound wave to and from the positioning node;
a wireless communicator having a connection function and time synchronization function with the positioning target terminal and acting as a slave of time synchronization;
a positioning node comprising a power supply controller which controls a power to transmit and receive a sound wave to and from the positioning target terminal;
a communicator to communicate with the positioning target terminal and acquire a reception time of the sound wave transmitted and received between the positioning node and the positioning target terminal; and
a positioning server comprising a positioning calculator which performs a positioning calculation of the positioning target terminal based on the reception time.

19. The system according to claim 18, wherein the positioning server transmits information according to a result of the positioning calculation to the positioning target terminal.
